(19) United States
(12) Patent Application Publication
(10) Pub. No.: US 2016/0283564 A1
(43) Pub. Date: Sep. 29, 2016

(54) PREDICTIVE VISUAL SEARCH ENGINGE

(71) Applicant: Dejavuto Corp., Palo Alto, CA (US)

(72) Inventors: Eitan Sharon, Palo Alto, CA (US); Or Cohen, Menlo Park, CA (US)

(73) Assignee: Dejavuto Corp., Palo Alto, CA (US)

(21) Appl. No.: 14/669,821

(22) Filed: Mar. 26, 2015

(51) Int. Cl. G06F 17/30

(52) U.S. Cl. CPC G06F 17/30554; G06F 17/30442; G06F 17/3053

(57) ABSTRACT

A predictive visual search engine is provided to assist a user to find an inventory item based on an image. A query is seeded by use of tags related to or generated from a target image. Results from a database are returned and a query is supplemented by tags associated with selected search results. Iterative responses are used until the results converge maximally or to the satisfaction of a user. The tags may be weighted to enhance the predictive nature of the search.

### BACKGROUND OF THE INVENTION

1. Field of the Invention

The invention relates to an image search engine, and particularly to a predictive search engine.

2. Description of the Related Technology

Online shopping offers a huge variety of items to be purchased by a click of a button. As a result, the task of finding a desired product in retailer websites is becoming difficult. This is especially true for fashion products, for which there exists a large variety of colors, materials and designs features that are difficult to describe in words. The two main search approaches employed in this field, free textual search and search by categories, often require expert knowledge and are limited in their ability to narrow down on fine design features.

A search engine is an information retrieval system designed to help find information stored on a computer system. The search results are usually presented in a list and are commonly called hits. Search engines help to minimize the time required to find information and the amount of information which must be consulted.

Search engines provide an interface to a group of items that enables users to specify criteria about an item of interest and have the engine find the matching items. The criteria are referred to as a search query. In the case of text search engines, the search query is typically expressed as a set of words that identify the desired concept that one or more documents may contain. It can also switch names within the search engines from previous sites. Whereas some text search engines require users to enter two or three words separated by white space, other search engines may enable users to specify entire documents, pictures, sounds, and various forms of natural language. Some search engines apply improvements to search queries to increase the likelihood of providing a quality set of items through a process known as query expansion.

The list of items that meet the criteria specified by the query is typically sorted, or ranked. Ranking items by relevance (from highest to lowest) reduces the time required to find the desired information. Probabilistic search engines rank items based on measures of similarity (between each item and the query, typically on a scale of 1 to 0, 1 being most similar) and sometimes popularity or authority (see Bibliometrics) or use relevance feedback. Boolean search engines typically only return items which match exactly without regard to order, although the term Boolean search engine may simply refer to the use of Boolean-style syntax (the use of operators AND, OR, NOT, and XOR) in a probabilistic context.

To provide a set of matching items that are sorted according to some criteria quickly, a search engine will typically collect metadata about the group of items under consideration beforehand through a process referred to as indexing. The index typically requires a smaller amount of computer storage, which is why some search engines only store the indexed information and not the full content of each item, and instead provide a method of navigating to the items in the search engine result page. Alternatively, the search engine may store a copy of each item in a cache so that users can see the state of the item at the time it was indexed or for archive purposes or to make repetitive processes work more efficiently and quickly.

Other types of search engines do not store an index. Crawler, or spider type search engines (a.k.a. real-time search engines) may collect and assess items at the time of the search query, dynamically considering additional items based on the contents of a starting item (known as a seed, or seed URL in the case of an Internet crawler). Meta search engines store neither an index nor a cache and instead simply reuse the index or results of one or more other search engines to provide an aggregated, final set of results.

Prior visual search engines are designed to search for information through the input of an image with a visual display of the search results. Information may consist of web pages, locations, other images and other types of documents. This type of search engines is mostly used to search on the mobile Internet through an image of an unknown object (unknown search query). Examples are buildings in a foreign city. These search engines often use techniques for content based image retrieval. A visual search engine searches images, patterns based on an algorithm which it could recognize and gives relative information based on the selective or apply pattern match technique.

Depending on the nature of the search engine there are two main groups, those which aim to find visual information and those with a visual display of results. An image searcher is a search engine that is designed to find an image. The search can be based on keywords, a picture, or a web link to a picture. The results depend on the search criterion, such as metadata, distribution of color, shape, etc., and the search technique which the browser uses. A metadata searcher is based on comparison of metadata associated with the image as keywords, text, etc. and it is obtained a set of images sorted by relevance. The metadata associated with each image can reference the title of the image, format, color, etc. and can be generated manually or automatically. This metadata generation process is called audiovisual indexing.

In a search by example technique, also called content-based image retrieval, the search results are obtained through the comparison between images using computer vision techniques. During the search it is examined the content of the image such as color, shape, texture or any visual information that can be extracted from the image. This system requires a higher computational complexity, but is more efficient and reliable than search by metadata.

There are image searchers that combine both search techniques, as the first search is done by entering a text, and then, from the images obtained can refine the search using as search parameters the images which appear as a result. CamFind is an example of a mobile visual search engine. The prior art also includes various techniques applicable to searching.

Section 1.1-1.6 in Brandt, A., Livne, O. E., Multigrid Techniques—1984 Guide with Applications to Fluid Dynamics (Revised Edition); SIAM, Philadelphia, Pa. relates to an elementary acquaintance with multigrid properties.

### SUMMARY OF THE INVENTION

An object of the invention is to provide an image driven search, where the user may seek an item starting with a visually related impression of search parameters or an image containing cues to a desired search result. In the latter case it is not effective to compare the image of the item with all the items in a database using conventional vision algorithms. The state-of-the-art vision algorithms are unable to narrow down on a set of items which is small enough to be reviewed quickly by a human.

According to an aspect of the invention, human input may be combined with text analysis and vision algorithms. This cyborg approach allows for a quick and precise matching between the item in the target photo and the corresponding item in the database. As a by-product, this approach produces a set of items which are similar to the target item. This set may be useful in other aspects of online shopping.

This approach is presented in the context of a database of fashion items, however, the invention is readily applicable to other contexts including, but not limited to, face detection and a more general image search. The invention is applicable to using visual cues as search queries against a database containing images and is not limited to fashion.

A predictive visual search system may have a tag selection manager responsive to a user interface. An output of the tag selection manager may be one or more tags representing search terms. A token selection manager responsive to a user interface may be provided where an output of the token selection manager one or more tokens. A token translation manager may be responsive to an output of the token selection manager and may have an output of two or more tags for each token. A search engine may be provided responsive the output of the tag selection manager and the output of the token translation manager. An item database may be provided containing a plurality of records, where each record identifies a respective item and includes an identification of one or more tags representative of features of the items and an image, representative of the items. The search results determined by the search engine may be provided to the user interface. The search engine may have a weighting unit responsive to the outputs of the tag selection manager and the token translation manager. The weighting unit may be a frequency weighting unit. The weighting system may apply progressively greater relative weight to sequentially later selections. The search results may be images associated with items matched by the search engine. The records may be formatted as feature vectors. The search engine may include a vector generator responsive to the tag selection manager and the token translation manager. The tag selection manager may be responsive to an image designated by the user interface and generates tags on the basis of image analysis. The tag selection manager may be responsive to an image designated by the user interface and may generate tags on the basis of metadata regarding the image. The tag selection manager may be responsive to an image designated by the user interface and may generate tags on the basis of text associated with the image. An image analysis engine responsive to the tag selection engine may be configured to analyze an image designated by the user interface and return tags suggested by the image.

A predictive visual search method may include the steps of identifying a target image generating a set of tags on the basis of the target image using a set of tags as search terms against an item reference database and generating a set of search results, each represented by an image token related to a set of tags corresponding to each result; designating one or more image tokens as a search token; combining tags associated with the search token and other tags to formulate a search query. The method may include the step of populating an item database with features associated with selected items. The items may be context-based. The context may be fashion.

Various objects, features, aspects, and advantages of the present invention will become more apparent from the following detailed description of preferred embodiments of the invention, along with the accompanying drawings in which like numerals represent like components.

Moreover, the above objects and advantages of the invention are illustrative, and not exhaustive, of those that can be achieved by the invention. Thus, these and other objects and advantages of the invention will be apparent from the description herein, both as embodied herein and as modified in view of any variations which will be apparent to those skilled in the art.

### BRIEF DESCRIPTION OF THE DRAWINGS

FIG. 1A shows an embodiment of a user interface for a visual search engine.

FIG. 1B shows an embodiment of a user interface for a visual search engine.

FIG. 2 shows a flowchart according to an embodiment of the invention illustrating user engagement with search tool.

FIG. 3 shows a flowchart according to an embodiment of the invention illustrating an interaction between a client device and a search engine.

FIG. 4 shows a flowchart according to an embodiment of the invention illustrating a text-based predictive visual search (PVS) engine.

FIG. 5 shows a sample illustration of a transformation of a user input into an input of a text search engine.

FIG. 6 shows a flowchart according to an embodiment of the invention illustrating a multiple source predictive visual search (PVS engine.

FIG. 7 shows a flowchart according to an embodiment of the invention illustrating a computation of feature-vectors.

FIG. 8 shows a sample illustration of a connectivity graph between items and tags.

### DETAILED DESCRIPTION OF THE PREFERRED EMBODIMENT

Before the present invention is described in further detail, it is to be understood that the invention is not limited to the particular embodiments described, as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range is encompassed within the invention. The upper and lower limits of these smaller ranges may independently be included in the smaller ranges is also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, a limited number of the exemplary methods and materials are described herein.

It must be noted that as used herein and in the appended claims, the singular forms “a”, “an”, and “the” include plural referents unless the context clearly dictates otherwise.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided may be different from the actual publication dates, which may need to be independently confirmed.

User Interface

An embodiment of the predictive visual search (PVS) engine, described herein may be incorporated as part of a web application used in mobile phones, tablets and desktop computers. It is to be understood that practical considerations of bandwidth, computing power, memory and other computational resources may indicate that particular features or functions be implemented in a user device, native app, web app, or server, the invention, unless required by the claims.

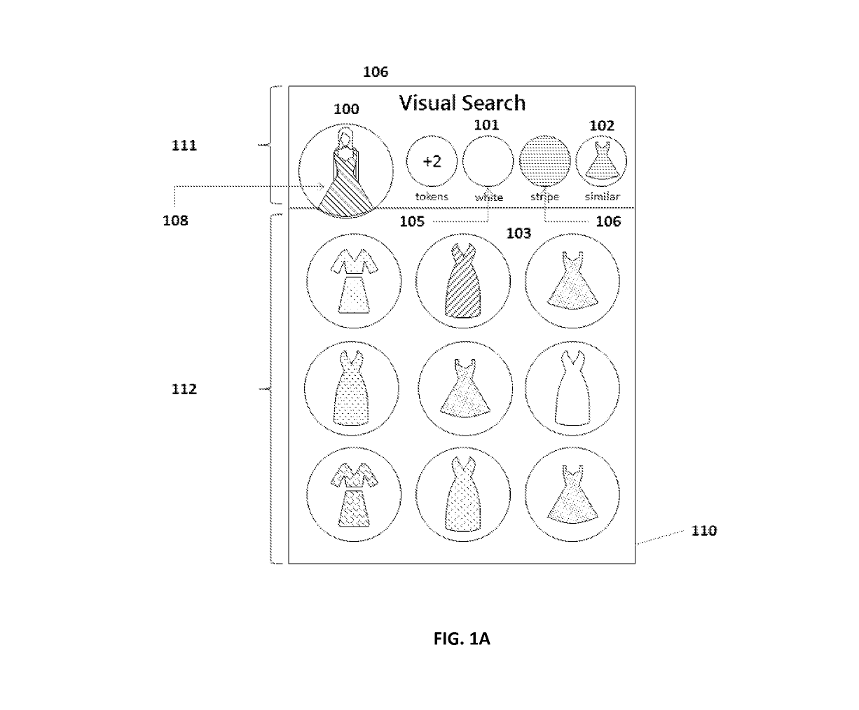

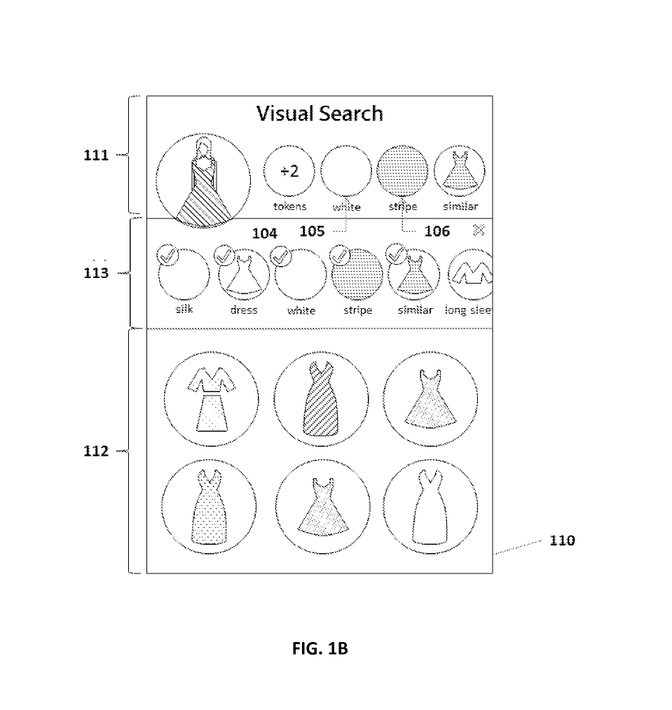

FIG. 1A shows an embodiment of a user interface. The user interface may be arranged with a search bar 111 and a search results pane 112. The search bar 111 may include a target item display 100, a tag panel 102 showing icons 105, 106 as tags representing features of a target item 108 in target item image 100.

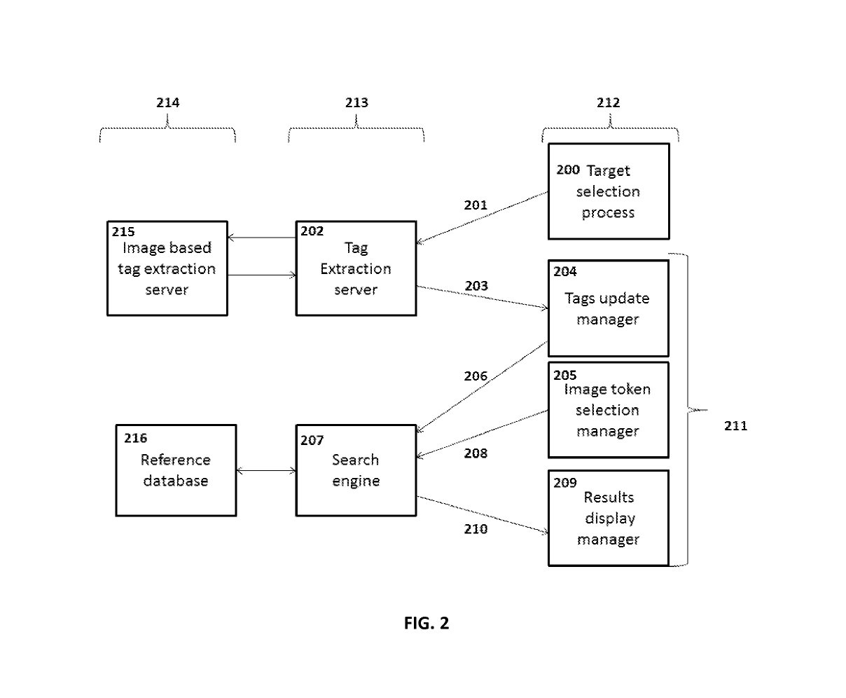

A flowchart of a typical user engagement is shown in FIG. 2. The interface may display an image 100 including a representation of a target item 108. The user may use the predictive visual search (“PVS”) engine to locate an item which is the same or similar to the target item 108. The target item 108 may represent an item available for purchase. The image 100 may be stored in a device such as a smartphone. The image may be captured by a camera in a user smartphone. The image 100 may be specified by the location it is stored. In one embodiment it may be stored at an accessible network location specified by a URL. The URL corresponding to the location of the image may be specified by a user interface and sent from a web application to a server along with any associated data indicating a category of the target item. The image 100 and/or information associated with the image 100 may be processed to derive a set of candidate tags relating to the image 100. The candidate tags may be selected, deselected or modified by a user. Tags are advantageously used to search an inventory database. The tag derivation processing may be performed on a mobile device or on a server connected to or in communication with the mobile device. Use of the server for processing requires a greater communication bandwidth, but shifts use of computational resources away from a user device and to a server. The processing device may use vision algorithms and/or text search to identify one or more tags that describe the target item from the image 100 or text associated with the image 100, for example text from a web page including or associated with the image 100 or metadata associated with the image 100. These tags may be chosen from a database of tags prepared in advance as described herein. The tags may be transmitted to the web application and may be represented on the interface by corresponding icons 105, 106 in the tag panel 101.

The process flow illustrated in FIG. 2 shows the processes specified by platform, according to one embodiment of the invention. According to an embodiment illustrated in FIG. 2 client processes 212 are executed on or in connection with a client device. Server processes 213 may be executed on a host server and vision processes 214 may be executed on a further server.

The tag identification by vision processes 214 may be performed by a cloud-based image based tag extraction server 215 such as CamFind http://camfindapp.com, MetaMind http://metamind.oi/, or Clarifai http://www.clarifai.com. The server processes 213 may send a URL pointing the service to an image 100. Alternatively, or in addition, the target image 100 may be sent to the recognition server third party processes 214. The processes 213 and 214 may operate on a segment that is only a part of the entire image 100. Advantageously the segment eliminates portions of the full image that do not include a target item 108. The image-based extraction server may be provided as a cloud service from a third party and may perform a context-oriented object detection analysis on the image to identify and return relevant tags which may be further processed by a server.

Addition or update of tags may be displayed in the search bar 111 of the interface 110. The client processes 212 include a target selection process 200 whereby the image 100 may be specified, identified, or provided. The image or information representative of the image to server processes 213. In addition, a context for the target item 108 may be provided to tag extraction server 202. Context identification would not be required in a single context system such as a fashion item only search, however context may be helpful in distinguishing between a fashion item search and for example, a vehicle or face recognition search. These two may implicate different approaches to characteristics represented by tags to be extracted.

The tag extraction process 202 may be performed by a server process 213 and/or managed by server process 213 and performed by [an image-based tag extraction server 215, advantageously provided by a third party].

Context may be utilized as a parameter to indicate what server to communicate with for tag extraction. According to one possible embodiment, text-based tag extraction may be performed by tag extraction server 213, however any image-based extraction may be performed as a third party extraction process 214. One or more image-based tag extraction server 215 may be called to perform image processing designed to yield a coarse set of tags on the basis of context or filtered according to context. Tag extraction server 202 may also provide tags to the user interface 110 to be displayed in the search panel 111.

A search engine 207 is provided in order to identify results from a reference database 216. The search engine 207 operates on one or more tags corresponding to those displayed in the search bar 111 or otherwise specified. Tags may be provided to search engine 207 directly from tag extraction process or from a client process 212. For example, tag transmissions 203 may provide tags from tag extraction server 202 to tag update manager 204. The tag update manager 204 displays an updated set of tags on the user interface and provides updated tags or changes in tags to search engine 207 by transmission path 206.

An additional or alternative tag designation may be accomplished by a user selection of one of the search results identified by search engine 207 to form the basis for an updated specification of search parameters. In addition it is possible for a user to manually enter one or more additional tags on the basis of direct identification, text input or selection from generic or context-based set of available tags.

An image token selection manager 205 responds to user input selecting an image token to provide a notification 208 to the search engine 207

The items contained in the reference database 216 may have an associated image. The associated image may be a thumb nail image. The image associated with the results identified by the search engine 207 may be provided by path 210 to the results display manager 209. The associated image is referred to as an “image token.”

Search engine 207 updates search results based on tag updates and image tokens selected. The transmission path 210 provides the search engine result updates to the results display manager 209. The user may select or designate additional tokens and/or image tokens. Processes 204 through 210 to be repeated.

The tag update manager 204 and image token selection manager 205 may communicate refinements to the search specification to the search engine 207. The user may select updates to the tags and/or image token selections to refine the search and may make repeated refinements until the search results converge.

FIG. 1B illustrates a user interface including suggested tags 104. At any point a user may change selected tags by activating a tag selection process, for example by clicking the search bar 111 to open a tag selection panel 113 as shown in FIG. 1B. Tag selection panel 113 may show one or more suggested tags 104. Suggested tags 104 may include a predetermined set, a context-based set, a set generated by a tag extraction server 211 or the search engine 207. The interface may also include an option for a user to type a custom tag or ad hoc tag.

The tags generated by tag extraction servers process 202 or 215 may represent a coarse set of features for the search engine 207. Finer features may be specified by selecting one or more of the image tokens from the search results that exhibit features of the [target] item. The image token selection manager 205 issues a notification 208 to the search engine 207 upon the adoption or removal of an image token from the search specification. The search engine 207 may refine the search results as described below and return a set of search responses.

In the user interface shown in FIG. 1, the process of adding an image token may be done by tapping a search result in 112 once and then tapping it again for confirmation. In other implementations of this invention this procedure can be done by other means, such dragging the search result to the top bar or double-tapping it.

Server-Side Architecture

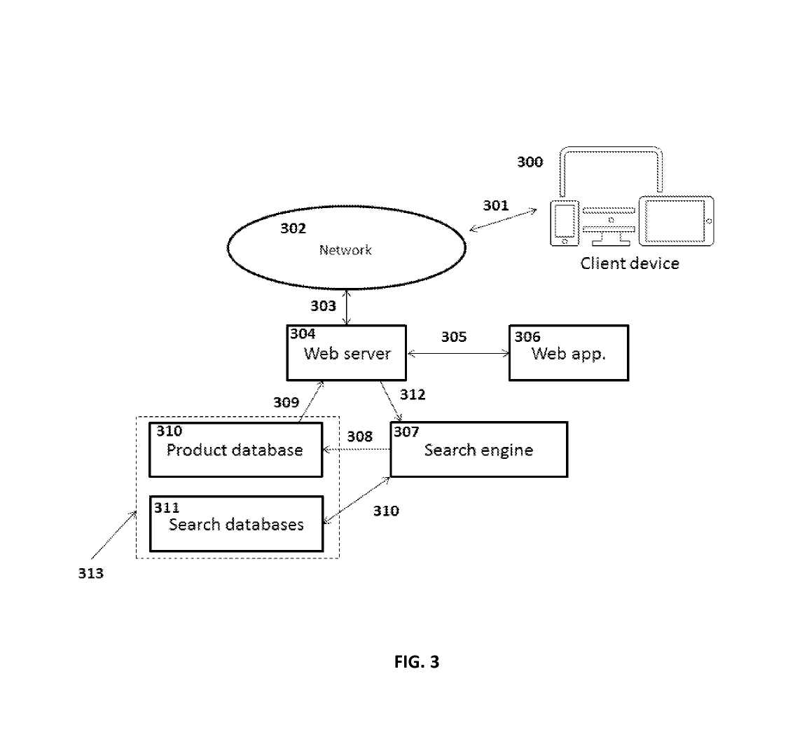

FIG. 3 shows a schematic of an embodiment of the invention. A client device 300 may communicate over a network 302 and communication channels 301 and 303 with a web server 304. The network 302 may be the internet. The web server 304 may communicate with a web application 306 and may send search requests to a search engine 307. The search engine 307 may be connected to a database 313 which may be a reference database and organized with a dedicated product database 310 and a search database 311. The search function may identify one or more search results contained in the search database 311. The records in the search database 311 may be indexed to corresponding records in a product database 310. According to an embodiment the reference database may be organized with the image information located in the search database 311 and metadata located in product database 310.

Search Algorithm Based on Text Only

The entries in the product database 310 may have one or more text fields containing text descriptive of a corresponding item. The text-based description text fields may be used in conventional text-based image and product searches. In the case of fashion products the descriptive text may be specified by a retailer for the purpose of helping a shopper find products. The text may be retailer-provided descriptions and may contain important tags that describe features of the product (e.g. category, color, material).

Tags

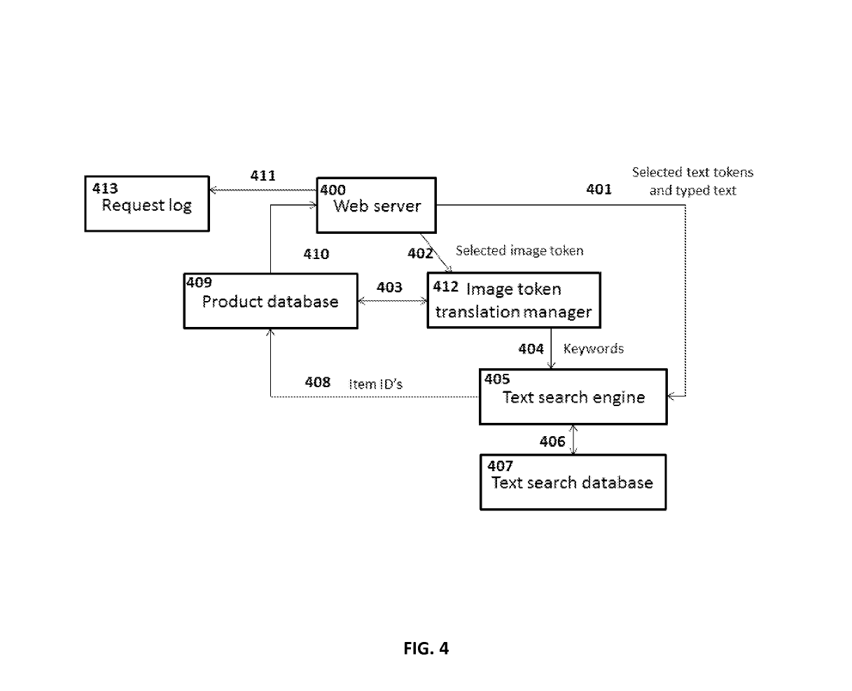

FIG. 4 shows an embodiment of a subsystem for executing text-based visual search. When there is text describing a product, not all words are relevant to the category of the product. For example in the text of fashion, one category may be women's sandals. Amazon describes a particular pair as “With barbeques, bonfires, and luaus to attend you'll need our stitched accent T-step sandal to keep party vibes alive! Its stitched faux leather upper looks so stylish with your tunic and shorts, while the criss-crossed ankle straps keep your foot secure during those spontaneous limbo contests.” Only a few words are suitable to serve as tags descriptive of a feature in the product category. The words suitable to serve as tags for a “sandal” from this description are stitched accent, t-strap, sandal, stitched, faux leather upper, criss-crossed, and ankle straps. In this way the words in the description fields of the items in the product database 409 may be mapped to a relevant feature. Relevance may be based on context. These words and terms (combinations more than one word) may be used as tags. Conventional methods may be used for identifying words suitable to operate as tags. For example, words suitable to operate as tags may be selected manually in a process where a description field of an item is shown to an editor in a consecutive order. The editor can examine the frequency of each word. Based on this information and his/her judgment the editor may mark the words and terms that will serve as a tags. A process may be used that shows descriptions of successive products in a category to an editor and the display of the description fields, the words that have already been reviewed may be omitted. This process converges very quickly to a point where virtually all the possible description words related to the entries have been reviewed.

This process can be used to populate a reference database for the tag extraction server. For example text associated with an input image can be compared to a library containing words and terms selected as being suitable to products within the context. The tag extraction server may identify matching elements to be used as tags and be presented to a user or a user and a search engine.

FIG. 4 shows server side elements according to an embodiment of the invention. The records of the text search database 407 and records of the product database 409 are associated. While they may be combined, separation facilitates enhancing search responses. The full record for a particular product may be stored in the product database 409 and the records may be indexed by an Item ID to information in the text search database 407 reflecting relevant features of the product.

An image token translation manager 412 obtains keywords 404 from selected image tokens 402 obtained from web server 400. The image token translation manager 412 is connected to the text search engine 405 which uses the keywords 404 to search the text search database 407. The Item IDs 408 corresponding to the items of the search results are used to identify products in the product database 409. Identified product information 410 is transmitted to the web server 400. The product database 409 is connected by link 403 to the image token translation manager 412. The web server 400 may also be connected to provide selected text tokens and typed text 401 to the text search engine 405. A request log 413 is also used to store search queries 411 which may be used to improve similarities between items.

Search Results

Search results may be obtained by a text search engine 405 using a conventional search algorithm over a description field. The description field from the product database 409 may be stored in a dedicated text-search database 407, which may be optimized for the specific search algorithm used.

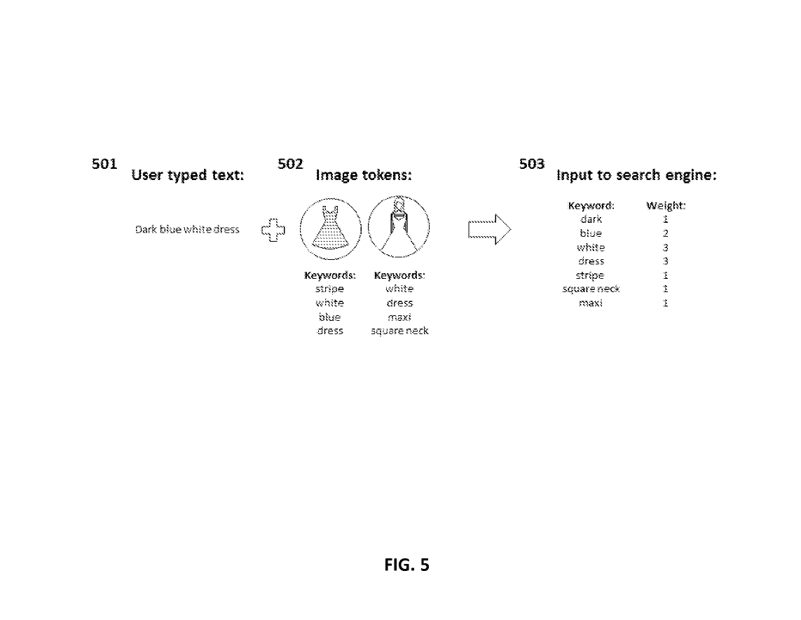

The tags selected by a user may be given directly as an input from a web server 400 to the text-search engine 405. The tags associated with user selected image tokens or an ID of any image token selected by the user are passed through a translation manager 402. Each tag associated with an image token refers to a feature of the item associated with the image token that may be added to the input 404 to the text search engine 405. This translation between image tokens and tags is illustrated in FIG. 5.

According to the embodiment illustrated in FIG. 5, the user-typed text 501 is an example of tags inserted by the user. The image tokens 502 represent search results selected by the user. The keywords for each image token are treated like tags and describe features of the item associated with each token. The selected tags and the keywords associated with the user-selected image tokens are combined and weighted according the number of occurrences of each term. For example, “dark” appears once in the user-typed text 501 and no times associated with the image tokens therefore the term “dark” has a weight of one. The tag “white” appears once in the user-typed text 501 and in both keywords sets of user-selected image tokens therefore the input to search engine 503 for the tag “white” is given a weight of three.

The search may be done by weighted entries. In the case of a fashion search embodiment it is useful to assign a weight proportional to the number of search results that correspond to the selected tag. Specific tags can be given a higher weight, based on their importance in the target category. Such weights may be optimized based on exemplary test cases. Tags 401 selected explicitly by a user may advantageously have a relatively higher weight (given by 2 in the example of FIG. 5). Another possibility is to assign a higher weight to tags that are found in the more recently selected results based updates. This is based on the assumption that the search gradually converges on a target item, and thus the more recent selection is more similar to the desired result. As in standard text-search algorithms, various other weighting schemes may be considered, which reflect the unique properties of the items in the database.

By using the tags contained in the user selected image tokens, a user is able to specify features that would otherwise require professional knowledge in order to describe in words, as well as emphasize certain features by selecting more than one item that contains a certain feature.

The calculation of the search results discussed above may also be done by standard algorithms of recommendation engines. Recommendation engines are based on representing each item selected by the user (such as books that he has bought) in terms of vector of feature that describe it. The engine then recommends the items in the database whose feature-vector best matches those the user has selected. In a similar manner, standard recommendation engines can be used in the present invention to yield a set of items from the database that best matches the tags and image tokens the user has selected.

Search Algorithm Based on Multiple Inputs

An additional level of information can be obtained from the user-selected image tokens to further focus a search by mapping visual similarities between the items in the database, either using vision algorithms or based on human input. This section describes the mapping of such similarities, their efficient storage in a database and their use in choosing the search results.

The visual similarities between items may be expressed numerically, by a number between −1 and 1, where 1 represents full identity. In order to avoid storing a large matrix of these similarity measures, which scales as the number of items squared, the algorithms described below produce a compact vector for each items, called a feature vector. Each vector is an array of N double-digit numbers, typically taken to be N=80. For simplicity the vectors are taken to be L2-normalized. The similarity between two items is measured by the inner product of the corresponding feature vectors. The inner product varies between −1 and 1, where 1 denotes complete identity between the items.

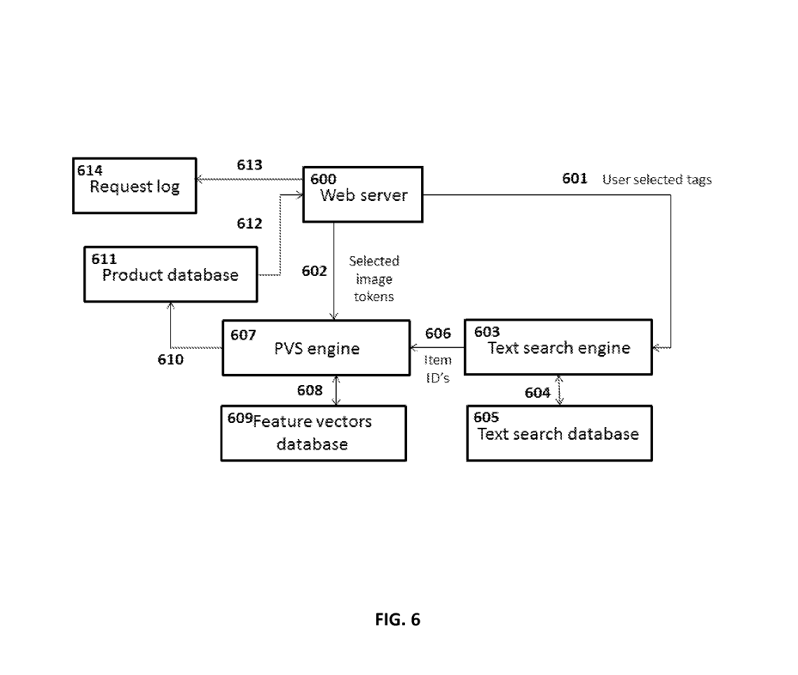

The search engine is schematically illustrated in FIG. 6. The web server 600 sends the user selected tags 601 to a conventional text search engine 603, which produces a set of item IDs whose description contains these tags. The text search engine 603 may use a dedicated database 605, where the items' descriptions are indexed in an optimal way. The Item IDs 606 of the item which corresponds to the selected tags are passed to the Predictive Visual Search (PVS) engine 607. The PVS algorithm uses the feature vectors of the items, stored in a dedicated features vectors database 609, and the Item IDs 606 of the selected tags to rearrange the search results and put at their head the most suitable ones. The item IDs 606 [610] found by the PVS engine 607 may then be passed through the product database 611, where the search results are added information relevant for their display in the web application. In addition, the search queries 613 may be stored in a request log 614 which can be used to improve the similarities between items.

Construction of Connectivity Graph

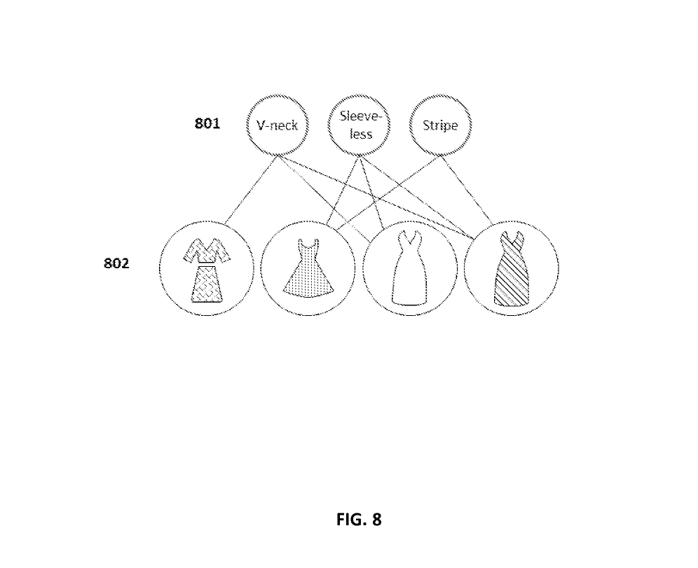

Similarities between items in the database may be mapped based on a connectivity graph between the items themselves and between items to layers of additional nodes, which correspond to tags and visual features. Each edge in the graph may be represented by a number which describes the level of similarity. A simple illustration of such a graph is shown in FIG. 8. These links are used in the calculation of the feature-vectors of the items. The links in the graph can be obtained from the following sources:

Tags: The tags 801 can be linked to items 802 in the graph, where the items and tags are represented by nodes. The weights may be positive and equal.

Vision algorithms: Existing vision algorithms can be trained to detect certain features of the items in the database, such as color, texture and shape. These algorithms yield a binary or fractional link between an item and a feature. These links can be used in a graph where the items and features are represented by nodes.

Direct votes by workers: Links between the items can be obtained from votes performed by operators who vote in a designated voting application. The operators may be presented at each vote a target item and several candidate items. They are requested to select the candidate item or several candidate items that are most similar to the target item. Each vote can be used to create links between the target items and the candidate items. The link between the target item and the selected candidate should have a positive weight. In certain cases it may be useful to add links with negative weights between the target item and the unselected candidates. In the present application the weights are computed based on a probabilistic model.

Search performed by users: The search tool discussed in section 2 can be operated based only on tags and vision algorithm, without any additional human input. The performance of the algorithm can then be gradually improved with additional human input. One way to obtain such an input is from the image tokens selected by users of the search tool. This is based on the assumption that each user selected image token is more similar to the target item than all of the items shown to the user since the last user selection of an image token. The users' selection can then be used to create a link between the target item and the items selected as image tokens.

Calculation of Feature Vectors

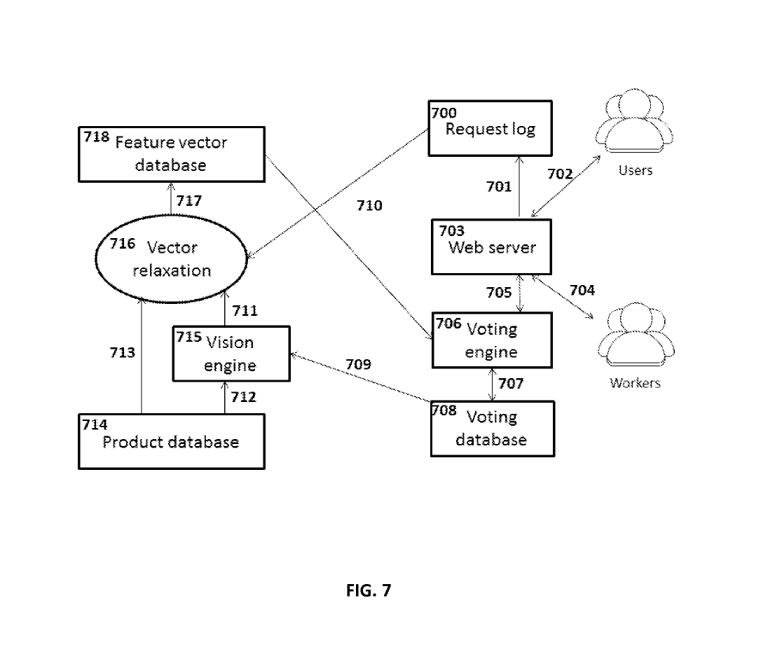

FIG. 7 illustrates the computation of feature vectors according to an embodiment of the invention. The results of voting performed by operators 704 may be transferred to the web server 703, and may be stored in a dedicated voting database 708. The candidates shown to the operators may be selected according to the algorithm discussed in the section above by the voting engine 706, based on the current feature vectors of the items 718. Additional sources of information may include searches performed by the user, stored in the request log database 700, vision engine 715, which extract visual features out of the images in the product database 714 and tags found in the description of the items 713.

The vectors are computed from these sources of information using standard techniques, such as the well-known Gauss-Seidel method by a vector relaxation processor 716. The relaxation method may be initiated by assigning random vectors to each node in the graph. In the presently discussed implementation it was found necessary to perform under relaxation. Depending on the size of the graph and its properties it may be necessary to perform a multilevel relaxation, based on the full multigrid cycle (FMG). The resulting vectors are stored in the feature vector database 718.

Search Results

The relaxation process described above may result in a compact feature vector for every item in the database. These can then be used for selecting the search results. The first step in this calculation is to compute the probability of each item in the database to be the target item 100. This probability distribution function is computed differently from tag and from user selected tags.

In the present implementation, a Matching Probability Distribution Function (MPDF), which describes the probability of each item in the database to be the target item the user seeks, may be computed from the tags by first passing the tags through a standard text-search engine. The MPDF may then be defined using a Gaussian drawn around the average feature vector of the items that appear in the leading results of the text-search engine. The variance of the Gaussian is proportional to the variance of the average state vectors of this group of items. The probability of every item in the database may then computed by evaluating this Gaussian at the position of its feature vector, and then normalizing the probability of all the items.

The above MPDF can be further refined using the user selected image token. This computation may be based on a probabilistic model which uses the vector of the user selected image token, ν_{q}, and the vectors of the items the user has seen prior to the selection, denoted by {νᵢ_{₁}, νᵢ_{₂}, . . . , νᵢ_{_{M}}}. The model describes the probability that the user is seeking for item k when selecting this result. One possible probability model is a Gaussian model defined in its unnormalized form as:

$${p}_{k} ≡ \frac{{e}^{- γ {r}^{2} ( {v}_{k} , {v}_{q} )}}{{\sum }_{j = 1}^{M} {e}^{- γ {r}^{2} ( {v}_{k} , {v}_{{i}_{j}} )}}$$

where r denotes the L2 distance between two vectors and γ is a parameter that has to be adapted to the properties of the database. In principle, γ may depend on {νᵢ_{₁}, νᵢ_{₂}, . . . , νᵢ_{_{M}}}.

The overall MPDF, which is a multiplication of those discussed above, yields the overall probability of each item to match the target item. The search results can then be taken to be all the items in the database, arranged in a decreasing order of probability. Another possibility is to arrange the search results in a manner that gives the user a wider variety of items in the initial stages of the search. This can be done by creating a relevance field which is a linear combination of the probability and the similarity of the item to the search results above it (measured by the dot product of the corresponding feature vectors).

Choosing Voting Candidates

The choice of the candidate items for the voting procedure discussed above may be done by two basic approaches:

Static tree: This is a tree of candidates, where the upper layers represent coarser styles. The tree may be constructed initially by selecting a small set of representative items from the entire set (about 6-12). All the items in the database are then voted as target against this set of candidates. The items are then split into (possibly overlapping) groups based on the operators' votes. In the next step another set of representatives may be chosen from each subgroup, which may then be further split using the same procedure as before. This process is repeated until the items are split into a sufficiently fine set of styles. The algorithm can be summarized by the following steps:
A. Select M representatives out of all the items.
B. Vote all items against the M representatives.
C. Split items in M branches based on the votes.
D. Repeat A-C for the items in each branch and continue splitting until the styles are sufficiently mapped. Typically a branch with less than 30 items should not be split any further.

Multilevel structure: This approach begins very similarly to the static tree approach. Here, however, after the first set of voting against the initial representative set of candidates, the feature vectors may be computed using the method discussed above. The feature-vectors may then be used to select a larger set of representative items. The size of the set should typically increase by a factor of 3. The next step may be a voting of all the items in the database, where each item is voted against the 6-12 most similar items in the representative layer (similarity measured by inner product of the feature vectors). This process is repeated until the items are split into a sufficiently fine set of styles. The algorithm may be summarized by the following steps:
A. Select M representatives out of all the items
B. Vote all items against the K most similar representatives (K<=M).
C. Compute feature-vectors for all items using relaxation.
D. Increase M by factor of about 3.
E. Repeat A-D until the styles are sufficiently mapped.

The selection of the representative items may be done manually at least in the coarse stages of the mapping. At later stages the representative can be selected automatically from the present feature-vectors of the items by splitting items into the corresponding number of clusters. The clusters can be obtained by conventional methods such as K-means or greedy aggregations of vectors based on the diameter of each cluster. The representative can then be chosen to be the center of each cluster.

One of the two approaches, discussed above, or a combination of the two can be used both to map the similarities in an existing database of items and to map newly added items. With additional information from the tags in the description of the items and image analysis, the similarities can be mapped with a relatively small amount of human input, which should be around 5 votes per item.

As an interim stage, prior to the voting of all of the items in the database, it may be useful to vote only a subset of items which represent the main features in each category of items (typically includes 5% of the items). The feature-vectors computed for this subset of items based on the votes may be used to compute a feature vector for every relevant tag in the description of the items. The feature vector of each tag may be taken to be vector that is most perpendicular to the feature vectors of the items in the subset whose description contains this tag. The feature vectors of the rest of the items in the database may be computed from the feature vectors of the tags using Gauss-Seidel relaxation, based on the graph illustrated in FIG. 8. This may improve the quality of the search results.

The invention is described in detail with respect to preferred embodiments, and it will now be apparent from the foregoing to those skilled in the art that changes and modifications may be made without departing from the invention in its broader aspects, and the invention, therefore, as defined in the claims, is intended to cover all such changes and modifications that fall within the true spirit of the invention.

Thus, specific apparatus for and methods of image searching have been disclosed. It should be apparent, however, to those skilled in the art that many more modifications besides those already described are possible without departing from the inventive concepts herein. The inventive subject matter, therefore, is not to be restricted except in the spirit of the disclosure. Moreover, in interpreting the disclosure, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

What is claimed is:

1. A predictive visual search system comprising:
a tag selection manager responsive to a user interface, wherein an output of said tag selection manager is one or more tags representing search terms;
a token selection manager responsive to a user interface wherein an output of said token selection manager is one or more tokens;
a token translation manager responsive to an output of said token selection manager and having an output of two or more tags for each token;
a search engine responsive to said output of said tag selection manager and said output of said token translation manager;
an item database containing a plurality of records wherein each record identifies a respective item and includes an identification of one or more tags representative of features of said items and an image, representative of said items; and
wherein search results determined by said search engine are provided to said user interface.

2. A predictive visual search system according to claim 1 wherein said search engine further comprises a weighting unit responsive to said outputs of said tag selection manager and said token translation manager.

3. A predictive search system according to claim 2 wherein said weighting unit is a frequency weighting unit.

4. A predictive search system according to claim 3 wherein said weighting system applies progressively greater relative weight to sequentially later selections.

5. A predictive visual search system according to claim 1 wherein said search results are images associated with items matched by said search engine.

6. A predictive visual search system according to claim 1 wherein said records are formatted as feature vectors; and
said search engine comprises a vector generator responsive to said tag selection manager and said token translation manager.

7. A predictive visual search system according to claim 1 wherein said tag selection manager is responsive to an image designated by said user interface and generates tags on the basis of image analysis.

8. A predictive visual search system according to claim 1 wherein said tag selection manager is responsive to an image designated by said user interface and generates tags on the basis of metadata regarding said image.

9. A predictive visual search system according to claim 1 wherein said tag selection manager is responsive to an image designated by said user interface and generates tags on the basis of text associated with said image.

10. A predictive visual search system according to claim 7 further comprising an image analysis engine responsive to said tag selection engine configured to analyze an image designated by said user interface and return tags suggested by said image.

11. A predictive visual search method comprising the steps of:
identifying a target image generating a set of tags on the basis of said target image;
using a set of tags as search terms against an item reference database and generating a set of search results, each represented by an image token related to a set of tags corresponding to each result;
designating one or more image tokens as a search token;
combining tags associated with said search token and other tags to formulate a search query.

12. A predictive visual search method further comprising the step of populating an item database with features associated with selected items.

13. A predictive visual search method according to claim 11 wherein said items are context-based.

14. A predictive visual search method according to claim 13 wherein said context is fashion.
